(19) United States
(12) Patent Application Publication
(10) Pub. No.: US 2019/0386383 A1
(43) Pub. Date: Dec. 19, 2019

(54) WIDE-BEAM ANTENNA WITH MODULAR MAIN RADIATOR

(71) Applicant: Amphenol Antenna Solutions, Inc., Rockford, IL (US)

(72) Inventors: Joshua W. SHEHAN, Melbourne, FL (US); Ryan Adams, Grand Forks, ND (US)

(21) Appl. No.: 16/439,318

(22) Filed: Jun. 12, 2019

Related U.S. Application Data
(60) Provisional application No. 62/684,838, filed on Jun. 14, 2018.
(60) Provisional application No. 62/696,538, filed on Jul. 11, 2018.

(51) Int. Cl. H01Q 1/24; H01Q 19/22; H01Q 19/10; H01Q 19/26; H01Q 1/52; H01Q 5/335

(52) U.S. Cl. CPC H01Q 1/246; H01Q 19/22; H01Q 5/335; H01Q 19/26; H01Q 1/52; H01Q 19/10

(57) ABSTRACT

A wide-beam antenna has a modular radiator. The antenna is designed specifically for small cell or DAS applications where wide azimuth beamwidth is required such as an antenna mounted to a building near street level. The main radiator of the antenna is modular where the module can incorporate filtering elements for interference mitigation. The modular main radiator also provides tuning capability for the antenna.

### RELATED APPLICATIONS

This application claims the benefit of U.S. Provisional Application No. 62/684,838, filed Jun. 14, 2018, and U.S. Provisional Application No. 62/696,538, filed Jul. 11, 2018. The entire contents of those applications are incorporated herein by reference.

### BACKGROUND OF THE INVENTION

### Field of the Invention

The present invention generally relates to antennas, and more specifically to the wide-beam antenna with a modular main radiator.

### Background of the Related Art

One of the major challenges facing today's wireless carriers is providing coverage and capacity in densely populated environments. One example is urban areas where high-rise buildings provide mounting locations for base station antennas, but they also make it difficult for wireless signals to propagate effectively at the street level. As a result, a rooftop mounting approach may not provide the desired coverage for optimal network performance. One alternative that has received considerable attention lately is the use of small cell antennas where a large number of low-gain antennas are deployed close to street level and distributed throughout the city. Small cell antennas may have unique pattern requirements depending on the mounting location. For example, an antenna may require wide azimuth beamwidth up to 180° to cover an open area along a street or along the side of a building.

Filtering is also desirable for small cell antennas where increased spectrum usage for cellular and other applications creates potential for interference that could degrade system performance. For example, 3.5 GHz and 5 GHz spectrum have recently been approved for mobile wireless services. To limit cost and meet zoning restrictions, wireless carriers generally prefer that multiband antenna be deployed where multiple antennas covering different bands are included in the same package. This could lead to coupling between bands that negatively impacts system performance, and filtering may be required to mitigate the inter-band coupling. There is also unlicensed spectrum in the 3-6 GHz range, and applications using these bands in an urban environment could interfere with a base station system operating from 1.695-2.7 GHz, or harmonics from the base station could create interference for nearby systems using spectrum in the 3-6 GHz range. Filtering is required to mitigate these risks.

Current wide-beam antenna approaches either do not incorporate filtering at the element, or filtering antennas do not exhibit wide enough beamwidth to be useful in the above-mentioned application. There is a need for broadband base station antennas that exhibit wide-beam operation and incorporate filtering for interference management.

### SUMMARY OF THE INVENTION

The present invention details a broadband, wide-beam antenna configured for linear polarization with a modular center conductor where filtering can be added without significant modification of the antenna. The antenna provides a wide beamwidth for operational environments requiring wide azimuth beamwidth as described in the related art. The radiating element is primarily formed as a sleeve monopole antenna with a grounded reflector and a parasitic director. The sleeve monopole antenna is inherently omnidirectional, but the addition of the reflector provides directionality in the radiation pattern. The parasitic director is found to improve elevation patterns over the operating band.

The antenna also includes filtering for interference mitigation. Additional services offered for advanced 4G and 5G systems increases the amount of spectrum usage at the base station, and interference may occur. Additionally, the mounting locations of small cell and DAS antennas for capacity enhancements in urban environments creates more potential for interference than for traditional tower-mounted macro antennas. The antenna of the present invention incorporates filtering similar to that described in U.S. patent application Ser. No. 15/395,170, Publication No. 2018-0138597 and “Sleeve monopole antenna with integrated filter for base station applications,” 2017 USNC-URSI Radio Science Meeting (Joint with AP-S Symposium), San Diego, Calif., 2017, pp. 11-12 for interference mitigation, but the filtering is incorporated as a module along with the main radiator. The main radiator/filtering module can be removed in the field to add filtering capability or remove filtering capability. Additionally, this modular approach could be applied to change the operating band of the antenna or change the filtered frequencies.

These and other objects of the invention, as well as many of the intended advantages thereof, will become more readily apparent when reference is made to the following description, taken in conjunction with the accompanying drawings.

### BRIEF DESCRIPTION OF THE FIGURES

FIGS. 1A-1F show the wide-beam antenna without filtering;

FIGS. 2A-2D show the filter element of the preferred embodiment that includes anti-interference filtering;

FIGS. 3A-3H show the wide-beam antenna with filtering along with the tuning section and filter support structure;

FIG. 4 shows the simulated return loss for the antenna with and without filtering;

FIGS. 5A-5B show simulated azimuth and elevation patterns for the antenna without filtering;

FIGS. 6A-6B show simulated azimuth and elevation patterns for the antenna with filtering;

FIGS. 7A-7C show a tuned radiator;

FIG. 8 shows return loss for FIG. 7; and

FIGS. 9A-9C show a wide-beam antenna.

### DETAILED DESCRIPTION OF THE PREFERRED EMBODIMENTS

In describing a preferred embodiment of the invention illustrated in the drawings, specific terminology will be resorted to for the sake of clarity. However, the invention is not intended to be limited to the specific terms so selected, and it is to be understood that each specific term includes all technical equivalents that operate in similar manner to accomplish a similar purpose. Several preferred embodiments of the invention are described for illustrative purposes; it being understood that the invention may be embodied in other forms not specifically shown in the drawings.

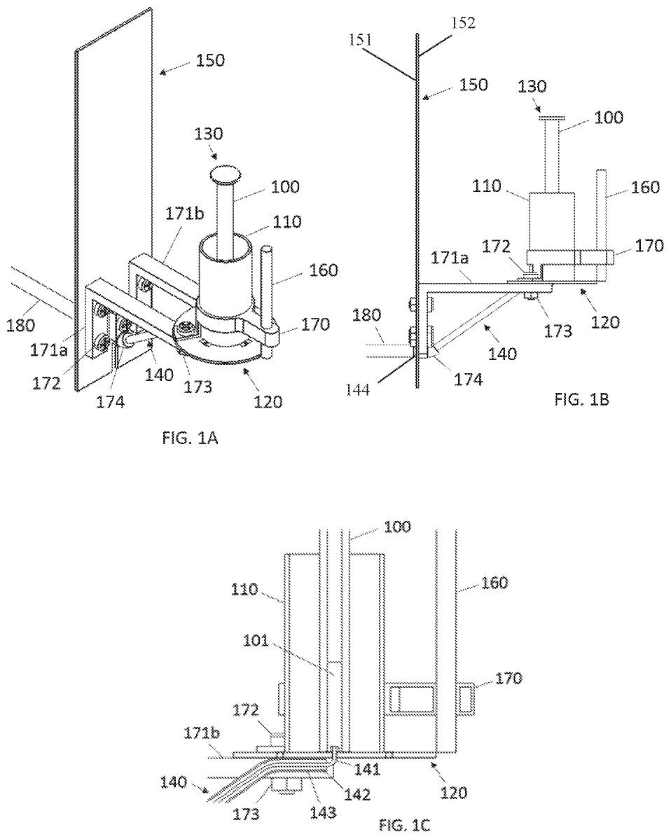

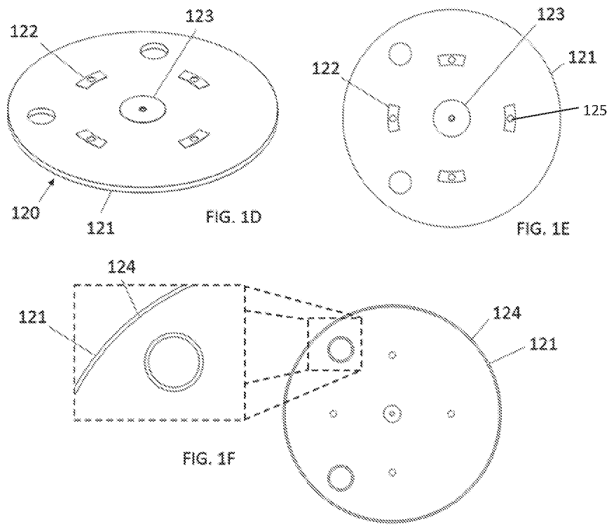

With respect to FIGS. 1A-1F, the wide-beam antenna is shown where the antenna has a sleeve monopole, a parasitic director 160, a grounded reflector 150, and a feed cable 140. The sleeve monopole primarily comprises a main radiator 100, a sleeve 110, and a substrate such as an RF feed printed circuit board (PCB) 120. In this embodiment, the main radiator 100 also includes a disk load 130 that helps with impedance matching the antenna primarily at the lower end of the operating band. The disk load 130 may be comprised of PCB material where only a single side (bottom side) is covered with copper. The copper is soldered to the main radiator 100 for direct electrical contact. The parasitic director 160, the sleeve 110, and the main radiator 100 are composed of material with high electrical conductivity such as copper or brass.

The RF feed PCB 120 is fabricated as a printed circuit board (PCB) with a bottom that has a copper layer 124 and an etch relief along the outer edge. The RF feed bottom copper layer 124 is soldered to the cable outer conductor 143 for grounding. The outer diameter of the bottom copper disk 124 is 31.75 mm. The top side of the RF feed PCB 120 includes four conductive pads or copper patches 122 arranged in a circular manner about the center of the RF feed PCB 120. These patches are arranged adjacent to the outer diameter of the sleeve 110, and these patches include a plated through hole 125 so that they are directly connected to the ground side of the RF feed bottom copper 124. The sleeve 110 is soldered to four copper patches 122 so that the sleeve 110 is in direct electrical contact with the ground side of the RF feed PCB 120.

The top side of the RF feed PCB 120 also includes a feed pad 123 where the cable center pin 141 is soldered to this feed pad 123. Referring to FIG. 1C, a main radiator support 101 is soldered to the feed pad 123 (FIGS. 1D-1F) and the cable center pin 141 where external threads may provide the ability to screw the main radiator 100 to the main radiator support 101. The main radiator 100 may have an interior opening that is threaded to match the threading on the main radiator support 101 providing the ability to attach or remove the main radiator 100. The main radiator support 101 can be a rod or tub and is received in the central bore or opening of the radiator 100 tube. The director 160, radiator 100 and sleeve 110 are all elongated members, each having a respective longitudinal axis, and all of which are substantially parallel to each other and to the plane of the reflector 150.

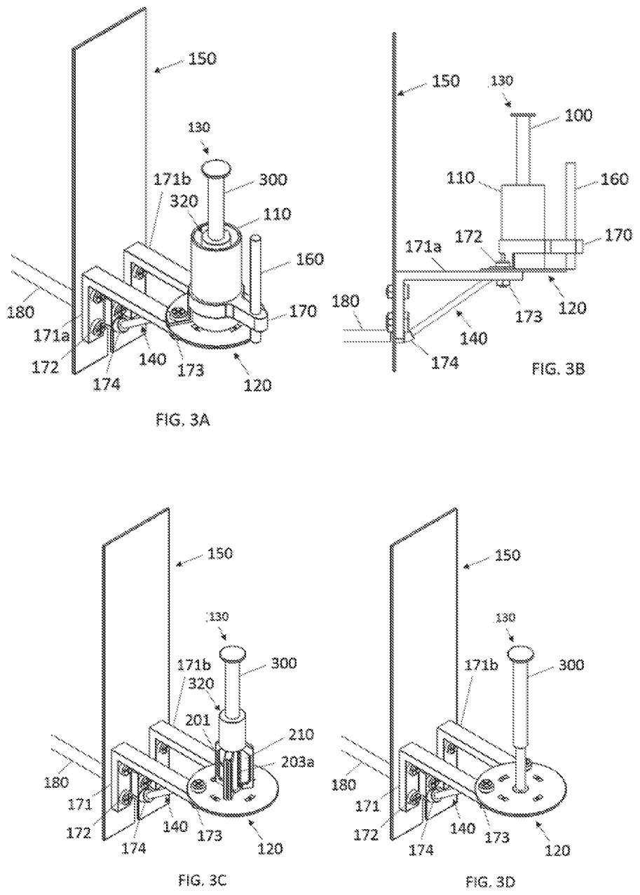

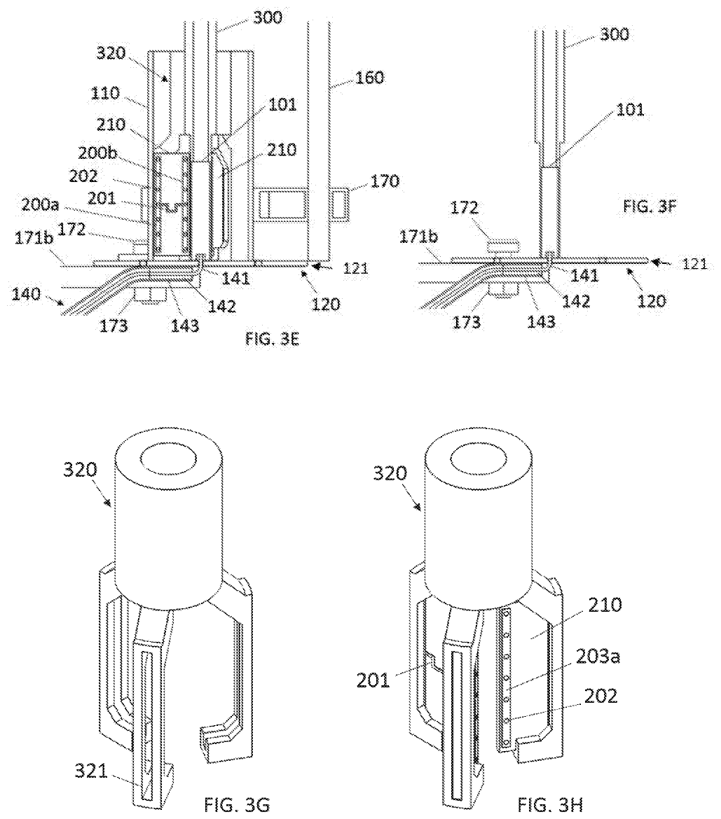

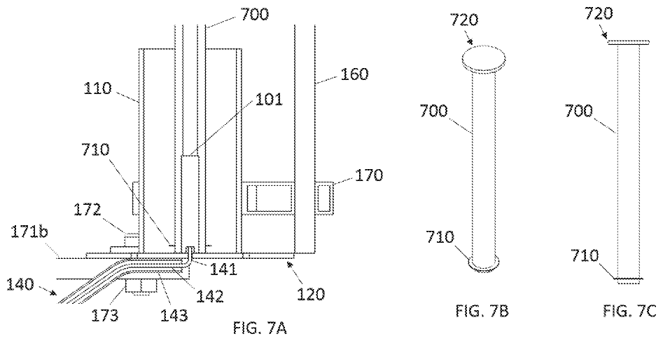

In addition, the sleeve monopole is modular in that different filter parts can be removed and replaced. For example, the main radiator 100 can be replaced by the radiator 300 of FIG. 3, and main radiator 700 in FIG. 7. The radiators 100, 300, 700 can be removed and replaced by other radiators 100, 300, or 700. The radiators 100, 300, 700 are threadably and removably engaged with the support 101.

The reflector 150 in the illustrated, non-limiting embodiment is composed of PCB material where only one side 151 is covered with copper. In one embodiment, the reflector 150 is a flat planar member with two sides 151, 152. The side 152 facing the primary components is non-conductive, and the side 151 opposite the primary components of the antenna is covered with copper. This copper is soldered to the cable outer conductor 143 for grounding, such as at solder point 144. The copper of the reflector 150 is 31.75 mm×127 mm. The sleeve 110 has an outer diameter of 15.875 mm with a wall thickness of 0.74 mm. The height of the sleeve 110 is 31.7 mm, and the distance between the sleeve 110 and the reflector 150 is 40.1 mm. The distance between the sleeve 110 and reflector 150 can be adjusted ±15% to increase or decrease the horizontal beamwidth.

In one embodiment, the main radiator 100 is a tube that is 58.2 mm tall with an outer diameter of 4.7625 mm. The parasitic director 160 is a solid rod with an outer diameter of 3.175 mm and a height of 40 mm. The parasitic director 160 is spaced 8.3 mm from the sleeve 110. The sleeve 110 is a tube with a central opening that receives the main radiator 100 such that the sleeve 110 is concentrically arranged about the main radiator 100. The inner diameter D of the sleeve 110 is substantially larger than the outer diameter d of the main radiator 100, to provide a gap or space between the sleeve 110 and the radiator 100. The ratio

$$\frac{D}{d}$$

can range from values of 3 to 7 and be optimized to provide impedance matching with negligible impact to radiation patterns.

As shown, the bottommost end of the radiator 100 and the sleeve 110 are substantially flush with one another and attach to the PCB 120. The radiator 100 is substantially longer in length than the sleeve 110, so that only a portion of the radiator 100 is surrounded by the sleeve 110, and the radiator 100 projects outward from the sleeve 110. The sleeve 110 is used to impedance match the radiator 100 over a larger frequency range i.e. >50% impedance bandwidth. The radiator is at least partly exposed to be able to communicate.

The disk load 130 is made of PCB material where the bottom copper has a diameter of 8.5 mm. The feed cable 140 is also fixed at a 55° angle relative to the longitudinal axis of the main radiator 100. This angle is chosen because the feed cable has an impact on the elevation patterns for the antenna. The 55° angle in addition to the parasitic director ensures satisfactory elevation patterns for the preferred embodiment where there is only approximately 6°-7° variation in the 10-dB elevation beamwidth at (p=90°. In the embodiment shown, the disk load 130 has a disk shape that is substantially flat and circular and is located at the topmost end of the radiator 100. The disk size can be used to optimize the impedance bandwidth of the modular radiator.

The antenna of the illustrated embodiment also includes an RF absorber 180 wrapped around the feed cable 140 after it passes the reflector 150. This minimizes pattern impacts from the feed cable 140. The RF absorber 180 can be, for example, ECCOSORB MCS produced by Laird Technologies, Inc. The material properties are simulated as εᵣ=38, tan δ=0.01, μᵣ=5, tan δₘ=0.6, where μᵣ is the relative permeability and tan δₘ is the magnetic loss tangent for the material. Note that for simulation of the antennas in this application, the feed cable 140 is modeled to extend approximately 46.75 mm past the back side of the reflector 150. The RF absorber 180 has a 1 mm gap from the back side of the reflector 150 and extends to the end of the feed cable 140. The RF absorber is modeled with a 1 mm thickness.

All PCBs have a dielectric thickness of 0.762 mm with a relative permittivity of εᵣ=3.38 and loss tangent tan δ=0.0035. The metallization on all PCBs can be 0.06 mm thick to account for 0.035 mm of copper and 0.025 mm of finish plating. The material thicknesses and dielectric properties can be chosen differently, but this may require retuning of the antenna.

The antenna is supported by non-metallic supports 171a, 171b to position the RF feed PCB 120 relative to the reflector 150. The supports 171 are L-shaped having a shorter leg 171a that attaches to the reflector 150 and a longer leg 171b that extends outward substantially orthogonal to the planar surface of the reflector 150 to form a shelf for the PCB 120. The PCB 120 is connected at the distal end of the longer leg 171b, to position the PCB 120 (as well as the radiator 100, sleeve 110 and director 160) at a desired distance from the reflector 150. The distance between the sleeve 110 and reflector 150 can be adjusted ±15% to increase or decrease the horizontal beamwidth.

A non-metallic director support 170 is included to position the director 160 relative to the sleeve 110. The director support 170 also includes mounting holes to ensure proper alignment of the director 160. The fasteners 172, 173 are non-metallic and are used to secure the antenna supports 170, 171a, 171b, 174 to the proper parts of the antenna. The director support 170 is formed by a support bracket having a first or proximal end with a ring and a second or distal end with an opening. The ring is substantially larger than the opening. The ring has a central opening that receives the sleeve 110 and supports the sleeve 110 on the PCB 120. The sleeve 110 can be connected to the ring in any suitable manner, such as by a friction fit, mechanical device or adhesive. The ring is positioned part-way up on the sleeve to provide better support to the sleeve 110 and the director 160.

A mounting bracket extends downward from the ring and forms a tab on the top surface of the PCB 120. A fastener 172 (such as a screw or bolt or the like) extends through an opening in the mounting tab, an opening in the PCB (FIG. 1D), and an opening in the longer support leg 171b to removably attach the mounting bracket, PCB 120 and longer support leg 171b together. The opening at the distal end of the director support 170 receives the director 160 and is connected to the director 160 in any suitable manner, such as by a friction fit, mechanical device or adhesive. The bottommost end of the director 160 is substantially flush with the top surface of the PCB 120, and the bottommost ends of the radiator 100 and sleeve 110. However, the director 160 is positioned outside of the PCB 120. The director 160 is longer than the sleeve 110, but shorter than the radiator 100, and the director support 170 retains the director 160 at a desired distance from the sleeve 110 and the radiator 100. The director 160 characteristics are a capacitive (shorter than resonant length) parasitic element used to direct the radiation pattern of the driven element radiator 100.

The feed cable 140 extends from the bottom of the PCB 120 to reflector 150. The fastener 173 attaches one end of the cable 140 to the bottom of the PCB 120. A non-metallic cable support 174 is used to support the feed cable 140 and maintain the appropriate angle. The cable 140 can extend through a slot at the bottom edge of the reflector 150 to the opposite side of the reflector 150.

The material for the support structures is selected to account for the dielectric properties of the support structures, which can impact the impedance match and the pattern performance of the antenna. In one embodiment, the support structures 170, 171a, 171b are 3D printed ABS (acrylonitrile butadiene styrene) where the desired fill factor is set to 5% to ensure minimal material is used while providing enough mechanical stability to properly secure all parts. This maintains a low dielectric constant to reduce material loading effects on the antenna. However, note that the particular geometry of the part and the 3D printer used to print the parts can impact the fill in certain regions and, as a result, material properties of the part. These effects are considered in the design where the wall thickness can be 0.5 mm, and the 3D printed ABS can have εᵣ=2.5 and tan δ=0.007. The cable support 174 can be 100% filled and does not have a significant impact on impedance matching or pattern performance for the antenna.

As the diameter of the monopole radiator 100 increases, it lowers the effective Q resulting in a smaller impedance variation over frequency than a smaller diameter. Loading at the top of the main radiator 100 with the disk load 130 increases the effective height of the radiator. The first resonance of the sleeve monopole occurs when the effective length of the radiator is one-quarter wavelength. This resonance is located at the lower end of the operating frequency band. Increasing the diameter of the disk load 130 can reduce the height of the main radiator to 70% of the required height of a monopole without disk loading. The main function of the sleeve 100 dimensions are to act as an impedance transformer to match the system to Z₀. The bottom portion of the sleeve 100 is soldered to the ground pads 122, which are connected to the ground plane 124 with plated-thru-hole vias creating a RF and DC short. The main function of the reflector 150 and director 160 is to focus the radiation from the radiator 100 generally in a line from the radiator 100 towards the director 160. Spacing between these components can be adjusted to produce different degrees of pattern focus but range from 0.1<λ<0.5.

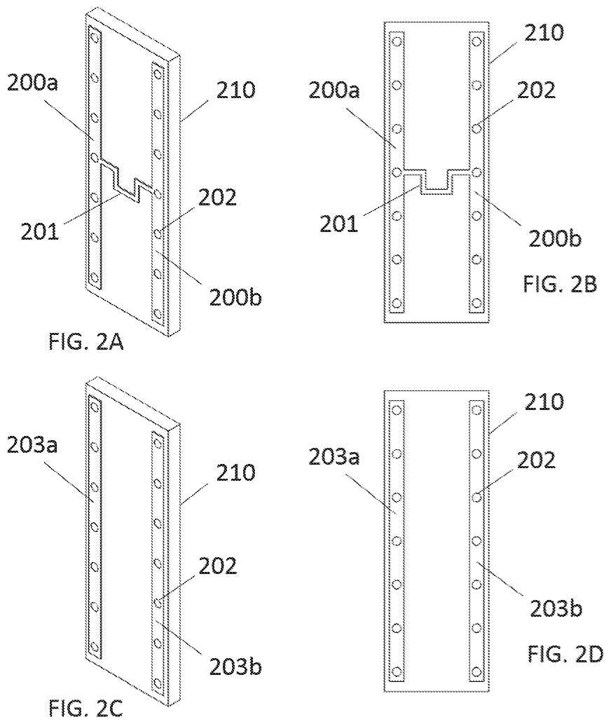

In an alternative embodiment shown in FIGS. 2-3, a filtered main radiator 300 may be used to suppress interference signals. Referring initially to FIG. 3, the filtered main radiator 300 in this embodiment has an overall height of 57.6 mm. In this case, the filtering is accomplished in a similar manner to that described in co-pending U.S. patent application Ser. No. 15/395,170, (Publ. No. 2018/0138597), the entire contents of which are hereby incorporated by reference, where three PCBs filters are used to achieve filtering from 3.3-5.925 GHz in this invention.

The filter elements used in the present embodiment are shown in FIG. 2. The filter elements are made of PCB material with a filter dielectric 210 having traces. The dielectric 210 is a flat planar member having a front surface and a back surface and is elongated having a length and a width. On the front surface of the dielectric 210 are formed front vertical copper traces 200a, 200b and a front horizontal copper trace 201. The vertical traces 200a, 200b are formed along the two peripheral sides of the length of the dielectric, shown on the left and right in the embodiment of FIGS. 2A, 2B. Thus, the vertical traces 200a, 200b extend linearly from the top end (nearly to the very top) of the dielectric 210 to the bottom end (nearly to the very bottom) of the dielectric 210. The front horizontal trace 201 extends transversely across the dielectric 210 from the left trace 200a to the right trace 200b. The horizontal trace 201 connects the left and right vertical traces 200a, 200b. The horizontal trace 201 can contain a U-shaped bend with orthogonal corners, as shown in FIGS. 2A, 2B. The horizontal trace 201 forms an inductive component for the filter circuit in FIG. 2A, 2B.

On the rear surface of the dielectric 210 are formed back vertical copper traces 203a, 203b. The vertical traces 203a, 203b are formed along the two peripheral sides of the length of the dielectric, shown on the left and right in the embodiment of FIGS. 2C, 2D. Thus, the vertical traces 203a, 203b extend linearly from the top end (nearly to the very top) of the dielectric 210 to the bottom end (nearly to the very bottom) of the dielectric 210.

In addition, plated through-holes 202 are provided along the front and back vertical traces 200, 203. The through-holes 202 extend through the dielectric 210 from the front surface where it connects with the front traces 200, to the rear surface where it connects with the rear traces 203. The through-holes 202 are plated to be conductive and provide a direct electrical connection between the front and back copper traces 200, 203. The plated through-holes reduce surface currents that reduce the filter performance.

The filter dielectric 210 has a thickness of 0.762 mm and the same dielectric properties as all other PCBs described previously. The copper traces 200a, 200b, 201, 203a, 203b can be 0.06 mm thick. The front vertical copper traces 200a, 203b and the back vertical copper traces 203a, 203b can have a height of 14.5 mm and a width of 0.75 mm. The horizontal copper trace can have a width of 0.25 mm and an overall length of approximately 5.36 mm. The overall height and width of the filter dielectric is 15.5 mm and 5.36 mm, respectively.

The full assembled antenna with filtering is shown in FIGS. 3A-3B. For purposes of illustrating the filter, FIG. 3C shows the antenna with the sleeve 110 removed and FIG. 3D shows the antenna with the sleeve 110, filter support 320, and filter elements removed. The only differences between the filtered antenna (FIG. 3) and the antenna without filtering (FIG. 1) is a modification of the original main radiator 100 to create the filtered main radiator 300 along with the addition of the filter support 320 and filters. Thus, the common elements of FIG. 3 are the same as those of FIG. 1 as discussed with respect to FIG. 1.

To modify the original antenna (FIG. 1) so that it is equipped with filtering (FIG. 3), the main radiator 100 can simply be removed from the main radiator support 101 and replaced with the filtered main radiator 300. The filtered main radiator 300 is made of a tube having a bottom portion and a top portion. As best shown in FIG. 3D, the bottom portion forms approximately one-third of the radiator 100, and the top portion forms approximately two-thirds of the radiator 100 that includes the middle and top sections of the radiator 100. The outer diameter of the top portion is larger than the outer diameter of the bottom portion, such that a lip is formed between the top and bottom portions, as best shown in FIGS. 3D, 3F. In one embodiment of the invention, the outer diameter of the top portion is 4.7625 mm, and the outer diameter of the bottom portion is 3.175 mm.

The bottom portion has a smaller outer diameter to accommodate the filter elements as well as provide impedance matching with the filter elements in place. The filter elements are based on metamaterial structures, and they generate an effective dielectric constant in the sleeve as described in U.S. patent application Ser. No. 15/981,556 (Publ. No. 2018/0261923), the entire contents of which are hereby incorporated by reference. The thinner main radiator section helps to accommodate this effective dielectric constant. The filter support 320 is used to support the placement of the filter elements, and the top portion of the filter support is used to help impedance match the antenna in an approach similar to that described in US Publ. No. 2018/0261923. The top portion of the filter support 320 has a height of 12.64 mm and an outer diameter of 9.1625 mm.

The filter support 320 is best shown in FIGS. 3G, 3H. The filter support 320 has a top portion and a bottom portion. The top portion is a tube with an inner diameter that is larger than the outer diameter of the top portion of the radiator 300. The top portion of the filter support 320 has a central opening that receives the radiator 300 and forms a friction fit. As shown, the top portion of the filter support 320 can be at the middle section of the radiator 300. The bottom portion of the filter support 320 has one or more legs that extend downward from the bottom end of the upper portion tube. The legs have a top end, an intermediate portion, and a bottom end. The top end forms a bend that extends transversely outward from the top portion of the filter support 320. The bottom end has a channel and the intermediate section has a slot 321. The channel and slot 321 together receive the filter dielectric 210 and form a friction fit to hold the filter dielectric 210 in a vertical position with one longitudinal side of each dielectric 210 extending inward toward the center to be adjacent the bottom portion of the radiator 300, such that the dielectrics 210 extend outward from the radiator 300 to the legs, as shown in FIGS. 3C, 3E.

The filter support 320 has a thickness of 0.8 mm on either side of the filter slots 321, and the filter support 320 is designed to position the filter dielectric 210 at a height of 0.8 mm from the RF feed dielectric 121. The filtered antenna of the embodiment shown includes 3 filter elements (such as the filter element of FIG. 2) spaced equidistant from each other at 120° around the filtered main radiator 300. The filter support 320 can have the same dielectric properties as the antenna supports 170, 171a, 171b, 174. The filter support has loading effects on the filter elements as well as to match to the antenna so this structure can be used to tune the response of the filter as well as the antenna impedance in the passband. These effects are considered in the design. Also note that a multitude of filtering options could be provided with the approach presented in this patent application. For instance, the filtering techniques applied in US Publ. No. 2018/0261923 can be applied to achieve multiband filtering. The filter placement and quantity can produce higher levels of rejection out-of-band frequencies as well as multiband rejection (filtering). As shown in FIG. 3A, the sleeve extends over and around the filter support 320 and the filter elements.

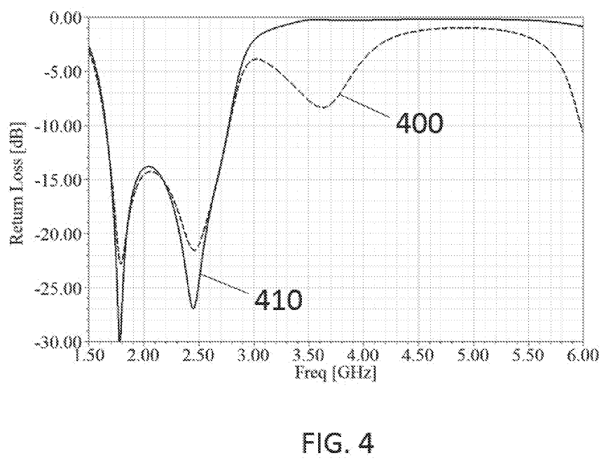

The simulated return loss for the antennas described herein are plotted in FIG. 4. The antenna without filtering (FIG. 1), line 400, exhibits a −10-dB return loss from 1.65-2.78 GHz, and the antenna with filtering (FIG. 3), line 410, exhibits a −10-dB return loss from 1.66-2.77 GHz. The antenna without filtering, line 400, exhibits regions from approximately 3.2-3.9 GHz and 5.8-6 GHz where the return loss drops below −5 dB. In these frequency bands, approximately 68% (or more) of the power incident on the antenna can be transmitted or received. Therefore, the antenna could receive or transmit interference degrading system performance for the antenna or creating interference for nearby antenna systems. The antenna with filtering, line 410, exhibits return loss between 0-(−0.85) dB from approximately 3.25-5.98 GHz where over 82% of the power incident on the antenna is rejected and only approximately 18% of the power can be transmitted or received. This significantly reduces the opportunity for the antenna to transmit or receive interference, and makes the antenna useful for collocated antenna systems covering multiple bands.

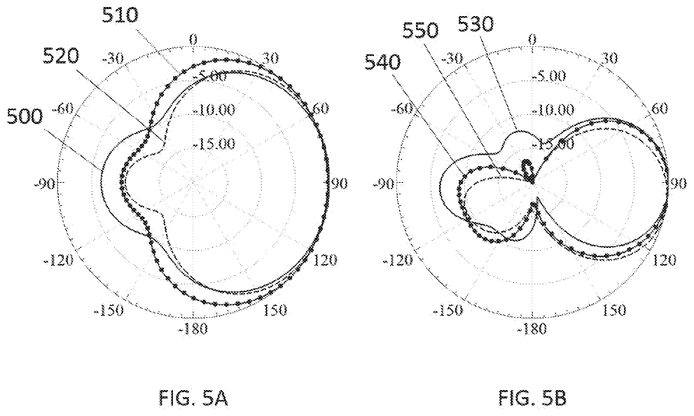

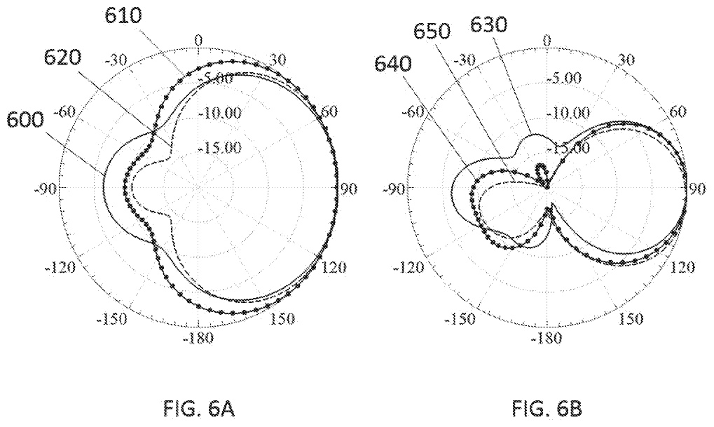

The simulated radiation patterns for the antennas described herein are plotted in FIGS. 5-6. FIG. 5A illustrates the azimuth (Az) patterns for the antenna without filtering. The 1.7 GHz Az pattern 500, 2.3 GHz Az pattern 510, and 2.7 GHz Az patterns 520 are shown. The Az patterns for the antenna without filtering are plotted through the peak of the main beam which shows some variation in elevation. As a result, the 1.7 GHz Az pattern 500 is plotted at an elevation angle of 90.5°, the 2.3 GHz Az pattern 510 is plotted at an elevation angle of 94°, and the 2.7 GHz Az pattern 520 is plotted at an elevation angle of 100.5°. The Az pattern for the antenna without filtering ranges from approximately 144°-181°.

The elevation (El) patterns for the antenna without filtering are shown in FIG. 5B. In this case, the elevation patterns are simply plotted at φ=90°. Note that there is some ripple in the main beam of the Az patterns, but simulations of the preferred embodiment show that the ripple does not exceed ˜0.3 dB. However, the peak of main beam in Az may not be at φ=90° for all frequencies in the operating band due to this ripple. The 3-dB El beamwidth at φ=90° ranges from approximately 610-65°, and the 10-dB El beamwidth at φ=90° ranges from approximately 108°-114°. The 1.7 GHz El pattern 530, 2.3 GHz El pattern 540, and 2.7 GHz El patterns 550 are shown.

The Az patterns for the antenna with filtering are shown in FIG. 6A. The 1.7 GHz Az pattern 600, 2.3 GHz Az pattern 610, and 2.7 GHz Az patterns 620 are shown. The Az patterns for the antenna with filtering are plotted through the peak of the main beam which shows some variation in elevation. As a result, the 1.7 GHz Az pattern 600 is plotted at an elevation angle of 90.5°, the 2.3 GHz Az pattern 610 is plotted at an elevation angle of 93.5°, and the 2.7 GHz Az pattern 620 is plotted at an elevation angle of 98.5°. The Az pattern for the antenna with filtering ranges from approximately 1430-1800.

The elevation (El) patterns for the antenna with filtering are shown in FIG. 5B. In this case, the elevation patterns are simply plotted at φ=90°. Note that there is some ripple in the main beam of the Az patterns, but simulations of the preferred embodiment show that the ripple does not exceed ˜0.3 dB. However, the peak of main beam in Az may not be at φ=90° for all frequencies in the operating band due to this ripple. The 3-dB El beamwidth at φ=90° ranges from approximately 61°-66°, and the 10-dB El beamwidth at φ=90° ranges from approximately 108°-115°. The 1.7 GHz El pattern 630, 2.3 GHz El pattern 640, and 2.7 GHz El patterns 650 are shown. Note that there is some variation in the radiation patterns between the antenna with filtering and the antenna without filtering, but these variations should not significantly impact coverage provided by the antenna with filtering vs. without filtering.

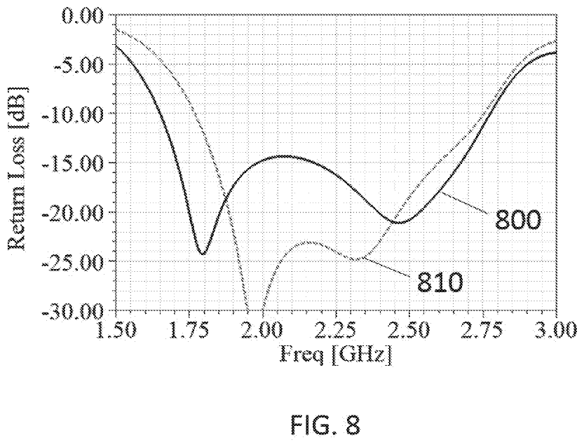

In another non-limiting example embodiment of the present invention, the antenna performance can be tuned by changing out the main radiator 100 (e.g., removing the radiator 100 and replacing it with another radiator 100). With respect to FIGS. 7A-7C, a first tuned main radiator 700 may be used instead of the original main radiator 100. In this case, the first tuned main radiator 700 is 52.9 mm tall and incorporates a capacitive ring 710 that is directly connected to the first tuned main radiator 700. The capacitive ring 710 is positioned substantially at the bottom end, spaced 1 mm from the bottom, of the first tuned main radiator 700 and is 6.35 mm in diameter. This main radiator 700 tunes the response of the antenna to that shown in FIG. 8 where the antenna match is optimized for the 1.9-2.4 GHz band.

The reduced height of the first tuned main radiator 700 shifts the antenna response to higher frequency compared to the original antenna of FIG. 1, and the capacitive ring 710 provides impedance matching in the desired frequency band. In this band, the tuned return loss 810 is better than −22 dB compared to the original return loss 800 obtained using the original main radiator 100 where the return loss is better than approximately −14 dB. Note that the first tuned main radiator 700 also incorporates a disk load 720 similar to the antennas in FIGS. 1, 3. The antenna is otherwise the same as shown in FIG. 1, and can be used with the filter of FIG. 3.

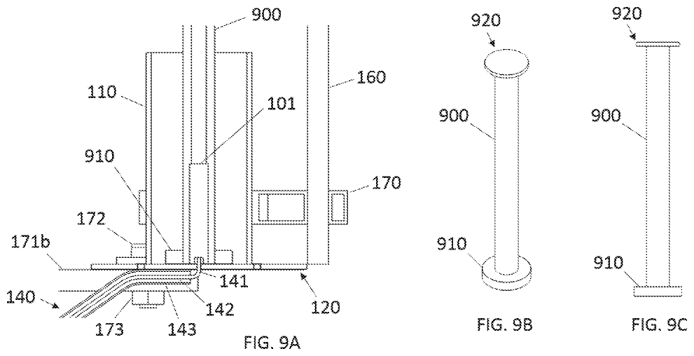

Turning to FIGS. 9A-9C, another embodiment of the present invention is shown. A similar technique is applied where a dielectric load 910 is used in the space between the sleeve 110 and a second tuned main radiator 900 for the purpose of tuning the antenna for a specific frequency band. The dielectric load 910 can have the shape of a ring positioned about the bottom end of the radiator 900 and can be flush with the very bottom end of the radiator 900. The load 910 can be any suitable dielectric material, or it may be an artificial dielectric material realized by subtractive or additive manufacturing techniques. The dielectric load 910 may also be realized as a metamaterial load. Note, that dielectric loading may also be used to tune the antenna for broadband performance. Any suitable dielectric loading method such as those described in U.S. Publ. No. 2018/0261923 may be used.

It is further noted that the electrical characteristics of the sleeve monopole can be adjusted by a number of features including but not limited to controlling the gap between the radiator 100 and the sleeve 110, the size and shape of the disk load 130, the size and shape of the sleeve 110, the distance between the main radiator 100 and the reflector 150, the size and shape of the director 160, the distance between the director 160 and the main radiator 100 and the sleeve 110, and the angle of the feed cable.

It is further noted that the description and claims use several geometric or relational terms, such as circular, parallel, orthogonal, concentric, planar, and flat. In addition, the description and claims use several directional or positioning terms and the like, such as top, bottom, left, right, up, down, inner, outer, distal, and proximal. Those terms are merely for convenience to facilitate the description based on the embodiments shown in the figures. Those terms are not intended to limit the invention. Thus, it should be recognized that the invention can be described in other ways without those geometric, relational, directional or positioning terms. In addition, the geometric or relational terms may not be exact. For instance, walls may not be exactly perpendicular or parallel to one another but still be considered to be substantially perpendicular or parallel because of, for example, roughness of surfaces, tolerances allowed in manufacturing, etc. And, other suitable geometries and relationships can be provided without departing from the spirit and scope of the invention.

Within this specification, the various sizes, shapes and dimensions are approximate and exemplary to illustrate the scope of the invention and are not limiting. The sizes and the terms “substantially” and “about” mean plus or minus 15-20%, or in other embodiments plus or minus 10%, and in other embodiments plus or minus 5%, and plus or minus 1-2%. In addition, while specific dimensions, sizes and shapes may be provided in certain embodiments of the invention, those are simply to illustrate the scope of the invention and are not limiting. Thus, other dimensions, sizes and/or shapes can be utilized without departing from the spirit and scope of the invention.

The foregoing description and drawings should be considered as illustrative only of the principles of the invention. The invention may be configured in a variety of shapes and sizes and is not intended to be limited by the preferred embodiment. Numerous applications of the invention will readily occur to those skilled in the art. Therefore, it is not desired to limit the invention to the specific examples disclosed or the exact construction and operation shown and described. Rather, all suitable modifications and equivalents may be resorted to, falling within the scope of the invention.

1. A wide-beam antenna comprising:
a sleeve monopole antenna having a sleeve and a feed cable;
a modular main radiator;
an electrically conductive reflector spaced a first distance from the sleeve monopole antenna; and
an electrically conductive director spaced a second distance from the sleeve monopole antenna.

2. The antenna of claim 1, wherein the reflector is electrically connected to the feed cable.

3. The antenna of claim 1, wherein the director is parasitic and held in place with a material that is not electrically conductive.

4. The antenna of claim 1, wherein the feed cable forms an angle relative to a longitudinal axis of the main radiator that is controlled for elevation pattern control.

5. A wide-beam antenna comprising:
a sleeve monopole antenna with a sleeve and a feed cable;
a modular main radiator;
one or more filter elements between the sleeve and the main radiator;
an electrically conductive reflector; and
an electrically conductive director.

6. The antenna of claim 5, where the reflector is electrically connected to the coaxial feed cable.

7. The antenna of claim 5, wherein the director is parasitic and held in place with a material that is not electrically conductive.

8. The antenna of claim 5, wherein the feed cable forms an angle relative to a longitudinal axis of the main radiator that is controlled for elevation pattern control.

9. The antenna of claim 5, wherein the one or more filter elements pass energy in one or more desired frequency bands and reject energy in one or more frequency bands.

10. The antenna of claim 5, wherein the one or more filter elements are held in place with a material that is not electrically conductive.

11. The antenna of claim 10, wherein the material holding the one or more filter elements in place tunes response of the antenna and/or response of the one or more filter elements.

12. The antenna of claim 1, wherein said main radiator is band-specific and tuned for optimal performance in a specific frequency band and an impedance match can be tuned by changing said main radiator.

13. The antenna of claim 12, wherein tuning features are added to the main radiator.

14. The antenna of claim 12, wherein the main radiator is machined to provide tuning.

15. The antenna of claim 1, wherein dielectric loading is used in a space between the sleeve and the main radiator for tuning.

16. The antenna of claim 15, wherein the dielectric loading provides an effective dielectric constant between the sleeve and main radiator and this effective dielectric constant exhibits spatial variability.

17. The antenna of claim 12, wherein a combination of metallic tuning features in the main radiator and dielectric loading are used for tuning.

18. An antenna comprising:
a substrate;
a radiator support having one end fixedly coupled to said substrate and an opposite end;
a main radiator removably coupled to the opposite end of said radiator support; and
a reflector coupled a first distance from said main radiator.

19. The antenna of claim 18, further comprising a parasitic element coupled at a second distance from said main radiator.

20. The antenna of claim 18, further comprising a sleeve fixedly coupled to said substrate about said main radiator, a filter support between said main radiator and said sleeve, and one or more filters coupled with said filter support.

21. A method comprising:
fixedly engaging a sleeve and a feed cable to a printed circuit board;
removably engaging a main radiator to the printed circuit board;
coupling a reflector at a first distance from the sleeve; and
coupling a director at a second distance from the sleeve.

22. The method of claim 21, directing by the director, a radiation pattern of the main radiator.

23. The method of claim 21, further providing the feed cable at an angle relative to a longitudinal axis of the main radiator to control for elevation pattern of the main radiator.
